(19) United States
(12) Patent Application Publication
(10) Pub. No.: US 2006/0081537 A1
(43) Pub. Date: Apr. 20, 2006

(54) Method and system for the treatment of liquid effluents containing pollutants in a suspension

(76) Inventors: Carlos Campos, Le Pecq (FR); Francois Bernazeau, Rueil Malmaison (FR); Jacques Moles, Rueil Malmaison (FR); William Levasseur, Appeville Dit Annebault (FR)

Correspondence Address: CONNOLLY BOVE LODGE & HUTZ LLP, SUITE 800, 1990 M STREET NW, WASHINGTON, DC, 20036-3425, US

(21) Appl. No.: 10/546,202

(22) PCT Filed: Feb. 26, 2003
(86) PCT No.: PCT/FR03/00627

§ 371 Date: Dec. 19, 2005

(51) Int. Cl. C02F 1/44

(52) U.S. Cl. 210/639

(57) ABSTRACT

A method for the treatment and filtration of fluids, i.e. liquid effluents such as raw water containing organic pollutants in a solution, using gravity separation means (10) such as a decantation and flotation means, and membrane separation means (13) in a finishing stage, wherein a first pulverulent reagent (1) is introduced into the flow of a fluid to be treated upstream from gravity separation, and a second pulverulent reagent (2) is introduced downstream from the membrane separation. The inventive method is characterized in that the coagulant required for separation is injected before the first pulverulent reagent; in that the first and second pulverulent reagents (1,2) have different characteristics, i.e. in terms of granulometry, adsorption capacity adapted to the pollutants which are to be eliminated; and in that the second pulverulent reagent (2) is recycled from membrane separation means (13) upstream from the gravity separation means (10).

The present invention relates to a process and to an installation for the treatment of liquid effluents, containing especially pollutants in solution, for example natural organic matter, micropollutants, etc.

Such processes and installations employ gravity separation means that include known systems of the settling tank type or flotation separator type, these being optionally followed by a granular filtration unit. It is known that, during the treatment of a liquid effluent, it may be necessary to use pulverulent reactants such as adsorbents (for example active carbon, bentonites or ion exchangers of the gel or macroporous type, with a standard or magnetic backbone). The addition of these reactants into the liquid effluent treatment line usually takes place at the same time as another reactant for promoting the coagulation, flocculation and gravity separation of the particulate impurities contained in the solution. Such an operation therefore makes it possible to remove the particulate, colloidal and dissolved impurities from the stream of liquid effluent to be treated. However, it is recognized that, to improve the effectiveness of this type of process, it is necessary to add the adsorbent reactant before the coagulant, since these suspended reactants behave as colloids and it is necessary to take account of their presence when adjusting the doses of reactants needed for the clarification.

The advent of membrane separation techniques, especially applications of ultrafiltration to the treatment of liquid effluents, makes it possible to improve the overall efficiency of clarification and filtration means installed upstream of the membrane separation means, the membranes having a separation efficiency of 100% in the case of particles that are larger than the separating power of the membranes used. In this context, it is desirable to inject the coagulant upstream of the adsorbent reactants—the metal hydroxide formed during the coagulation and flocculation is used to adsorb most of the organic matter (organic molecules of high molecular weight), thereby increasing the efficiency of adsorption of the residual organic matter and of the micropollutants by the pulverulent adsorbent.

Since it turns out that the organic matter and the micropollutants are in competition for the same adsorption sites, the efficiency of this type of system can be improved by increasing the number of points of injection and the types of adsorbent. For example, in a system that includes a settling tank followed by membranes, a first adsorbent will be added before the settling tank and a second before the membranes, each of the reactors being optimized according to the characteristics specific to the materials to be removed and to the adsorbents. It is to this type of installation that the present invention relates.

FR-A-2 628 337 in particular discloses installations for the purification of fluids by means of membranes, into which installations an adsorbent, for example pulverulent and/or granular active carbon, is introduced, this adsorbent being introduced before the filtration membranes into the stream of fluid to be purified.

Also disclosed, especially by U.S. Pat. No. 4,610,792, are installations for the treatment of polluted water that include clarification means and membrane separation means as finishing treatment. In this known type of installation, a pulverulent reactant, for example active carbon, is introduced into the raw water treatment line between the conventional clarification means and the membrane separation means, the pulverulent reactant being recirculated into the membrane filtration loop between the clarification means and the membrane separation means.

Also known are older systems for the addition of pulverulent reactants, in which the reactant is injected into the treatment line directly upstream of the gravity separation unit (flotation separator or settling tank).

Finally, installations are known (FR-A-2 696 440) for the purification of fluids that include gravity separation means and membrane separation means, in which the pulverulent reactant is introduced upstream of the membranes and the water for backwashing these membranes containing this pulverulent reactant is recirculated upstream of the gravity separation means.

Starting from this prior art, the present invention proposes improvements, for improving the efficiency of removing the dissolved pollution, while reducing the operating costs.

As a consequence, the subject of this invention is, firstly, a process for the purification and filtration of fluids, especially liquid effluents such as raw water containing organic pollutants in solution and employing gravity separation means such as in particular a settling tank and a flotation separator, and also membrane separation means, in a finishing step, in which process a first pulverulent reactant is introduced into the stream of the fluid to be treated, upstream of the gravity separation unit, and a second pulverulent reactant, upstream of the membrane separation unit, this process being characterized in that the coagulant needed for the separation is injected before the first pulverulent reactant, in that said first and second pulverulent reactants have different characteristics, especially particle size and adsorptivity suitable for the pollutants to be removed, and in that said second pulverulent reactant is recycled from the membrane separation means toward the upstream end of the gravity separation means.

According to the invention, the fact of adding the coagulant before the first pulverulent reactant into a reactor whose contacting time can moreover be adapted to the characteristics of the raw water (temperature, turbidity, organic matter, etc.) makes it possible to obtain an adsorbent residence time of generally between 5 and 20 hours, but never more than 60 hours, beyond which it has been observed that the efficiency of the first adsorption step is substantially reduced, in particular as regards the removal of miscropollutants.

According to one method of implementing the process as defined above, each of the pulverulent reactants is formed by adsorbents, especially active carbon, bentonites or ion exchangers of the gel or macroporous type, with a standard or magnetic backbone.

The invention also relates to an installation for implementing the process as defined above.

This installation comprises a treatment line including especially gravity separation means, membrane separation means, as finishing step, and means for the respective introduction of coagulant, of a first pulverulent reactant upstream of the gravity separation unit and of a second pulverulent reactant upstream of the membrane separation means, this installation being characterized in that it furthermore includes a loop for recycling the second pulverulent reactant from the purge of the membrane separation means back to the line in which the liquid effluent to be treated flows, upstream of the gravity separation means and in that the means for injecting the coagulant needed for the separation are located upstream of the means for injecting the first pulverulent reactant.

According to one embodiment of this installation, the gravity separation means are produced in the form of a clarifier, which may consist of a sludge bed settling tank or a sludge recirculator, optionally supplemented with a lamellar separator system and preceded either by a contacting zone, for the injection of the coagulant, or by a complete coagulation/flocculation step, the choice between the various combinations being guided by the time needed for the coagulant to form its first adsorption and by the residence time needed for the first pulverulent reactant to achieve an optimum adsorption efficiency.

According to another method of implementing the invention, the gravity separation means are produced in the form of a clarifier such as a flotation separator, optionally preceded either by a contacting zone for injecting the coagulant or by a complete coagulation/flocculation step.

According to the invention, the membrane separation means are formed by microfiltration, ultrafiltration, nanofiltration or even reverse osmosis systems that are equipped with plate-and-frame, tubular, spiral or hollow-fiber (external skin or internal skin) membranes. The gravity separation means may comprise a granular filter with ascending or descending current.

Other features and advantages of the present invention will become apparent from the description given below with reference to the appended drawings which illustrate exemplary embodiments of the invention, these being devoid of any limiting character. In the drawings,

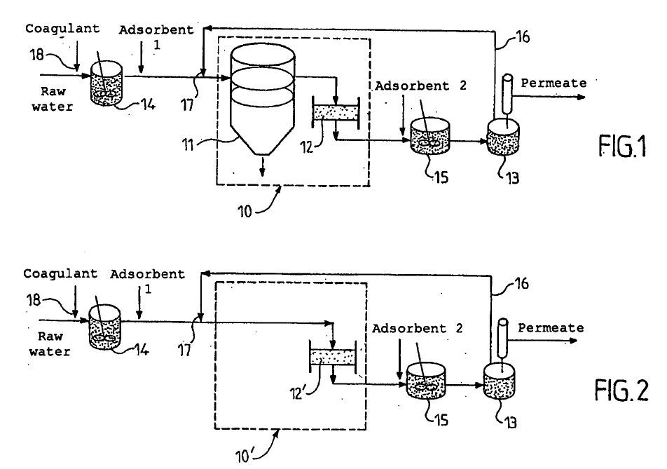

FIGS. 1 and 2 are schematic representations of two embodiments of a treatment installation for implementing the process according to the invention.

FIG. 1 shows that the installation according to the present invention comprises, as is known, a gravity separation means denoted in its entirety by the reference 10, which may consist of a clarifier 11 followed by a granular filter 12 and a membrane separation means 13, produced for example in the form of microfiltration, ultrafiltration, nanofiltration or even reverse osmosis systems. It will be noted that the clarifier 11 may consist of a sludge bed settling tank or a sludge recirculator or a flotation separator, or a settling tank, optionally supplemented with a lamellar separation system.

According to the invention, the installation provides for a coagulating reactant to be introduced at a point 18 into the raw water feed line, said line being followed by a mixing/contacting reactor 14, by means for introducing the first pulverulent reactant (adsorbent 1), upstream of the gravity separator 10 and downstream of the point of injection 18 of the coagulating reactant, and by a means for introducing the second pulverulent reactant (adsorbent 2) upstream of the membrane separator 13. A mixing/contacting reactor 15 is also provided between the means of introducing the adsorbent 2 and the membrane separation means 13.

According to the present invention, the installation also includes the recycling of the second pulverulent reactant (adsorbent 2), from the purge of the membrane separator 13, by means of a loop 16 that takes the second pulverulent reactant thus recycled back to a point 17 located on the raw water feed line, upstream of the gravity separator 10 but downstream of the point of introduction 18 of the coagulant.

As mentioned above, the pulverulent reactants (adsorbents 1 and 2) have different characteristics (materials, particle size, adsorptivity matched to the pollutants to be removed).

Referring now to FIG. 2, this illustrates an alternative embodiment of the installation according to the invention. In this embodiment it may be seen that the gravity separation means 10′ includes no clarifier and it may consist of a granular filter 12′ (with ascending or descending filtration), optionally preceded either by a contacting zone for injection of the coagulant or by a complete coagulation/flocculation step. The membrane separation means 13 may for example be produced in the form of ultrafiltration devices. This installation is particularly advantageous for the clarification of water in which the amount of colloidal matter and the amount of suspended matter are low.

According to the invention, and as previously, in this embodiment a means is provided for the introduction of a coagulating reactant at a point 18 on the raw water feed line, upstream of the point of injection of the first pulverulent reactant, said means being followed by a mixing/contacting reactor 14, by a means of injecting the first pulverulent reactant (adsorbent 1) at a point located upstream of the granular filters 12′ and by a means of injecting the second pulverulent reactant (adsorbent 2) upstream of the membrane separator 13. Recycling of the second pulverulent reactant (adsorbent 2) is also provided, coming from the purge for the membrane separator 13, by means of a loop 16 that takes the pulverulent reactant thus recycled back to a point 17 located on the raw water feed line, upstream of the gravity separator 10′ but downstream of the point 18 of injection of the coagulant.

Thus, compared with the known technique, as defined especially in the abovementioned publications, the invention differs by the fact that it employs two pulverulent reactants having different characteristics, these being added at different points on the treatment line, and by the fact that the coagulant is injected upstream of the first pulverulent reactant. Thanks to this arrangement, the efficiency of the adsorption of the various organic pollutants is optimized (since the effects of the coagulant and of the adsorbent do not counteract each other), while the operating costs of the system are reduced.

The results of trials for implementation of the process according to the invention, which indicate the increases in efficiency of the adsorption of organic matter (OM) and pesticides, are given below. These results are set out in Tables 1 and 2.

TABLE 1
Comparison of the percentage removal of organic matter
(TOC) for adsorbent injection (i) simultaneously with
and (ii) subsequently to coagulant injection.

| | | Coagulation at |
|---|---|---|
| | Simultaneous | t₀ = 0 followed |
| Contacting | coagulation and | by adsorption |
| time (mn) | adsorption | at t₀ + 3 mn |
| 0 | 0% | 70 |
| 10 | 57% | 71 |
| 20 | 65% | 76 |
| 30 | 65% | 80 |
| 60 | 68% | 82 |
| 120 | 70% | 85 |
| 180 | 72% | 90 |

In both cases, a coagulant dose of 60 mg/l of ferric chloride and an adsorbent dose of 15 mg/l of powdered active carbon (Norit W 35) were used on the same water containing 10 mg/l of TOC (Total Organic Carbon). The removal efficiency was greatly improved in the case of delayed injection.

TABLE 2
TOC adsorption efficiencies for various systems.

| | % removal: | % removal | |
|---|---|---|---|
| System | TOC | μ-pollutants | Comments |
| 15 mg/l of PAC₁ in | 30 | 50 | |
| a sludge bed | | | |
| settling tank | | | |
| 15 mg/l of PAC₂ in | 30 | 70 | (1) |
| membranes (cf FR 2628337) | | | |
| 15 mg/l of PAC₂ in | 45 | 75-80 | (2) |
| membranes + recirculation | | | |
| into the settling tank | | | |
| (cf FR 2696440) | | | |
| 10 mg/l of PAC₁ in | 55-60 | 90-99 | (3) (4) |
| the settling tank + | | | |
| 5 mg/l of PAC₂ | | | |
| in the membranes + | | | |
| recirculation into | | | |
| the settling tank | | | |

PAC₁ = powdered active carbon (Norit W 35), not screened (particle size: 50-100 μm);
PAC₂ = powdered active carbon (Norit S.A.U.F.), screened (particle size: 10 μm);
(1): knowing the contacting time in the sludge bed is 12 to 48 hours and that in the membranes is about 60 minutes, the high specific surface area of PAC₂ nevertheless makes it possible to obtain an equivalent result on TOC and a better result on miscropollutants;
(2): recirculation makes it possible to optimize the use of the total capacity of PAC;
(3): improved performance with cost reduction, since PAC₁ is substantially cheaper than PAC₂. The low dose of PAC₂ would even allow dead-end filtration, with no recirculation;
(4): PAC₂ is more effective on pesticides (miscropollutants) when the TOC has been reduced beforehand on PAC₁.

Compared with the other known processes employing the combination of gravity separation means with filtration plus membrane separation means, the invention in particular provides the following advantages:

the order of injection of the reactants (addition of a first pulverulent adsorbent reactant into a raw water that has been pre-coagulated) optimizes the overall removal of organic compounds (total organic carbon or TOC) with a high concentration (a few mg/l);

the addition of a second pulverulent adsorbent upstream of the membranes constitutes a double barrier for adsorption of miscropollutants (pesticides and compounds responsible for taste and odor) with a low concentration (a few μg/l). This second adsorbent is much more effective for the adsorption of miscropollutants, this resulting from the reduction, upstream, in the concentration of natural organic matter (TOC) by coagulation and adsorption;

the recycling of the second pulverulent adsorbent reactant from the membrane separation means to a point upstream of the gravity separation means (with a long residence time) makes it possible to saturate this pulverulent reactant and to increase the overall adsorption efficiency in the gravity separation means; and

the discharge from the membrane separation means, containing the second pulverulent reactant, is sent back into the sludge coming from the gravity separator, which contains the first adsorbent. This simplifies the problem of treating the sludge of the treatment line and minimizes the amount of water “lost” owing to the extractions.

Of course, it remains to be stated that the present invention is in no way limited to the exemplary embodiments and methods of implementation described and/or mentioned above, rather it encompasses all variants thereof.

1. A process for the purification and filtration of fluids, especially liquid effluents such as raw water containing organic pollutants in solution and employing gravity separation means such as in particular a settling tank and a flotation separator, and also membrane separation means, in a finishing step, in which process a first pulverulent reactant is introduced into the stream of the fluid to be treated, upstream of the gravity separation unit, and a second pulverulent reactant, upstream of the membrane separation unit, this process being characterized in that the coagulant needed for the separation is injected before the first pulverulent reactant, in that said first and second pulverulent reactants have different characteristics, especially particle size and adsorptivity suitable for the pollutants to be removed, and in that said second pulverulent reactant is recycled from the membrane separation means toward the upstream end of the gravity separation means.

2. The process as claimed in claim 1, wherein the residence time of the first pulverulent reactant in its contacting reactor is between 5 and 60 hours, preferably between 5 and 20 hours.

3. The process as claimed in claim 1, wherein the pulverulent reactants are formed by adsorbents, such as especially active carbon, bentonites or ion exchangers of the gel or macroporous type, with a standard or magnetic backbone.

4. An installation for implementing the process as claimed in claim 1, which comprises a treatment line including especially gravity separation means (10), membrane separation means (13), as finishing step, and means for the respective introduction of coagulant, of a first pulverulent reactant upstream of the gravity separation unit and of a second pulverulent reactant upstream of the membrane separation means, this installation being characterized in that it furthermore includes a loop (16) for recycling the second pulverulent reactant from the purge of the membrane separation means (13) back to the line in which the liquid effluent to be treated flows, upstream of the gravity separation means (10) and in that the means for injecting the coagulant needed for the separation are located upstream of the means for injecting the first pulverulent reactant.

5. The installation as claimed in claim 4, wherein the gravity separation means (10) are produced in the form of a clarifier, such as a sludge bed settling tank, optionally supplemented with a lamellar separator system and preceded either by a contacting zone, for the injection of the coagulant, or by a complete coagulation/flocculation step.

6. The installation as claimed in claim 4, wherein the gravity separation means (10) are produced in the form of a clarifier such as a flotation separator, optionally preceded either by a contacting zone for injecting the coagulant or by a complete coagulation/flocculation step.

7. The installation as claimed in claim 4, wherein the gravity separation means (10) are produced in the form of a clarifier, such as a sludge recirculator, supplemented with a lamellar separator system and preceded either by a contacting zone, for the injection of the coagulant, or by a complete coagulation/flocculation step.

8. The installation as claimed in claim 4, wherein the gravity separation means (10′) are produced in the form of a granular filter (12′) with ascending or descending current, optionally preceded either by a contacting zone for injecting the coagulant or by a complete coagulation/flocculation step.

9. The installation as claimed in claim 4, wherein the membrane separation means (13) are formed by microfiltration, ultrafiltration, nanofiltration or even reverse osmosis systems.
